(19) United States
(12) Patent Application Publication
(10) Pub. No.: US 2015/0039606 A1
(43) Pub. Date: Feb. 5, 2015

(54) SEARCH PHRASE MODIFICATION

(71) Applicants: Vamsi Krishna Salaka, Fremont, CA (US); Prathyusha Senthil Kumar, San Jose, CA (US); Brian Scott Johnson, Campbell, CA (US)

(72) Inventors: Vamsi Krishna Salaka, Fremont, CA (US); Prathyusha Senthil Kumar, San Jose, CA (US); Brian Scott Johnson, Campbell, CA (US)

(21) Appl. No.: 14/304,595

(22) Filed: Jun. 13, 2014

Related U.S. Application Data
(60) Provisional application No. 61/861,315, filed on Aug. 1, 2013.

(51) Int. Cl. G06F 17/30

(52) U.S. Cl. CPC G06F 17/30648; G06F 17/3064
USPC 707/730

(57) ABSTRACT

A user may submit a search string to a system. Before processing the search, the system may analyze the search string and modify it. For example, the search string may be modified by treating some terms as a phrase, by dropping some terms, by treating some terms as attributes, or any suitable combination thereof. The modification of the search string may be based on an analysis of prior search strings and user actions. The results of a search based on the modified search string may be returned to the user.

### CROSS-REFERENCE TO RELATED APPLICATIONS

This application claims the benefit of U.S. Provisional Application No. 61/861,315, filed Aug. 1, 2013, entitled “SEARCH PHRASE MODIFICATION,” which is incorporated herein by reference in its entirety.

### TECHNICAL FIELD

The subject matter disclosed herein generally relates to the processing of data. In one specific example, the present disclosure addresses systems and methods for search phrase modification.

### BACKGROUND

Search engines provide users the ability to enter search queries and view sets of results responsive to the search queries. A user may view the set of results generated for a search query, decide the results do not reflect what the user had in mind, and submit a modified search query. The user may repeat this process until satisfactory results are presented or the user gives up on the search.

### BRIEF DESCRIPTION OF THE DRAWINGS

Some embodiments are illustrated by way of example and not limitation in the figures of the accompanying drawings.

FIG. 1 is a network diagram illustrating a network environment suitable for search phrase modification, according to some example embodiments.

FIG. 2 is a screen diagram illustrating a type of search phrase modification, according to some example embodiments.

FIG. 3 is a screen diagram illustrating a type of search phrase modification, according to some example embodiments.

FIG. 4 is a screen diagram illustrating a type of search phrase modification, according to some example embodiments.

FIG. 5 is a block diagram illustrating components of a search machine suitable for search phrase modification, according to some example embodiments.

FIG. 6 is a block diagram illustrating components of a user device suitable for search phrase modification, according to some example embodiments.

FIG. 7 is a flowchart illustrating operations of a search machine in performing a method of search phrase modification, according to some example embodiments.

FIG. 8 is a flowchart illustrating operations of a search machine in performing a method of search phrase modification, according to some example embodiments.

FIG. 9 is a flowchart illustrating operations of a search machine in performing a method of search phrase modification, according to some example embodiments.

FIG. 10 is a flowchart illustrating operations of a search machine in performing a method of search phrase modification, according to some example embodiments.

FIG. 11 shows equations used in operations of a search machine in performing methods of search phrase modification, according to some example embodiments.

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems are directed to search phrase modification. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In a search system, a user may submit a search string that includes multiple terms to the search system. Before performing the search, the search system may process the search string. For example, the search system may modify the search string by grouping some of the terms into a phrase, dropping or otherwise removing some of the terms from the search string, treating some terms as attributes, or any suitable combination thereof.

According to some embodiments, modifying a search string may have many practical advantages. For example, in an e-commerce system that lists items (e.g., goods or services) available to the user for purchase, modifying the search string may, in some cases, increase the probability that the user will find an item of interest. For example, a user searching for a “used car” most likely wants a car that is used, not an item with both “used” and “car” in the description or title. Accordingly, modifying the search string to search for a “car” with the attribute of “used” may increase the probability that the user finds items of interest. As another example, a user searching for an “apple tv” most likely wants an Apple TV, not other products that contain both terms (such as a cable that can connect an Apple computer to a TV set). Accordingly, modifying the search string to search for “apple tv” as a phrase may increase the probability that the user finds items of interest.

In some embodiments, the modification of the search string may be based on an analysis of prior search strings and user actions. For example, if the same search string or a similar search string frequently resulted in the user interacting with items that would have been found with some terms treated as a phrase, the search string may be modified to treat those terms as a phrase. Similarly, if the same search string or a similar search string frequently resulted in the user interacting with items that would have been found with some terms dropped, the search string may be modified to drop those terms. Likewise, if the same search string or a similar search string frequently resulted in the user interacting with items that would have been found with some terms treated as an attribute search, the search string may be modified to treat those terms as an attribute search. In addition to considering the items interacted with by the user after a search, the sequence of searches performed by a user may be considered. For example, if a search is performed but no items are interacted with and then a second search is performed that contains fewer terms, the first search string may be modified to drop the terms omitted in the second search. Likewise, if the second search contains an attribute search, the first search may be modified to include the attribute search used in the second search. In some example embodiments, engagement by the user with items returned from the second search gives additional weight to the use of the second search.

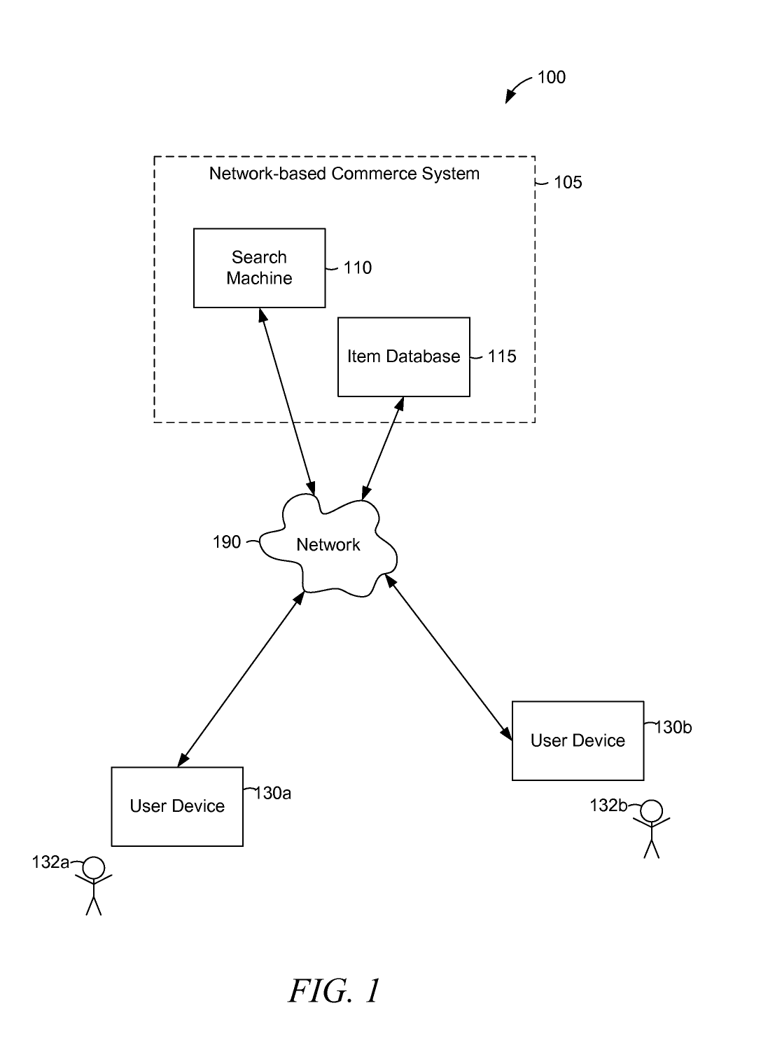

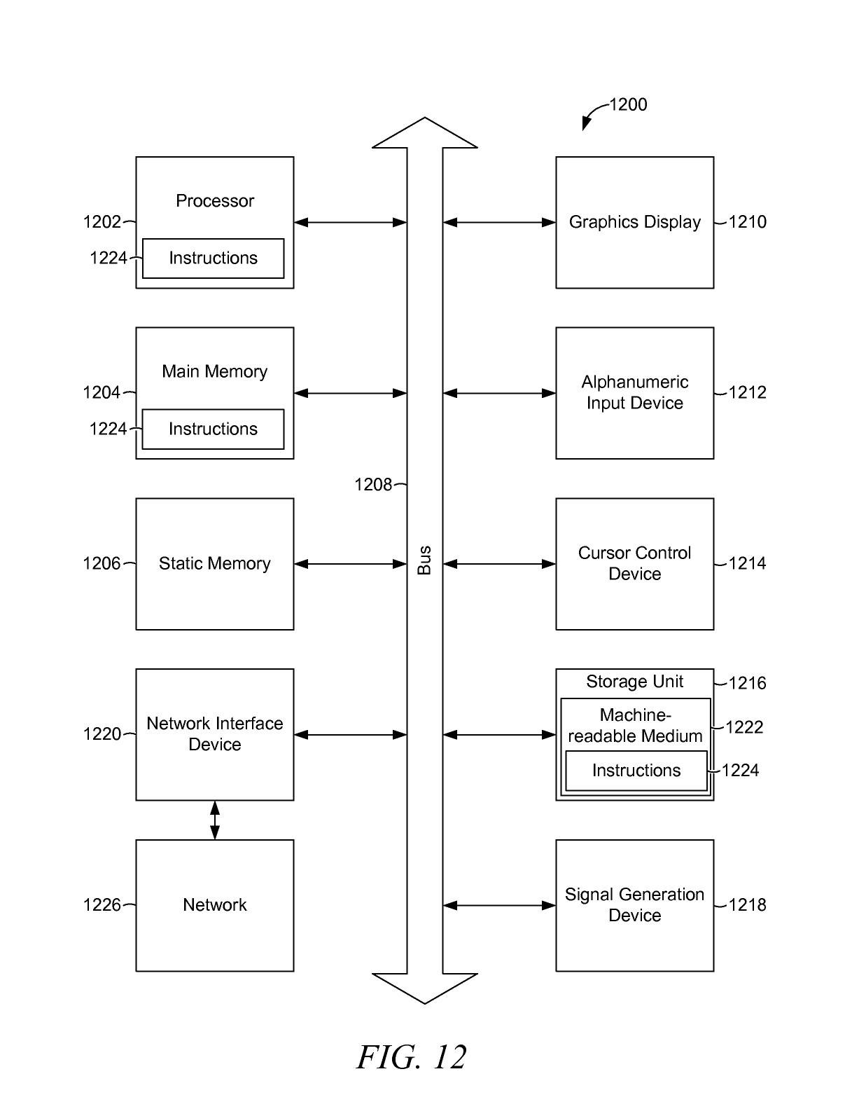

FIG. 1 is a network diagram illustrating a network environment 100 suitable for search phrase modification, according to some example embodiments. The network environment 100 includes a network-based commerce system 105 and user devices 130a and 130b, all communicatively coupled to each other via a network 190. The network-based commerce system 105 may comprise multiple servers (e.g., a search machine 110) and databases (e.g., an item database 115). Devices within the network-based commerce system 105 may communicate via the network 190 or another network. The network-based commerce system 105 may present a single interface to the network 190. The search machine 110 and the user devices 130a and 130b may each be implemented in a computer system, in whole or in part, as described below with respect to FIG. 12. The user devices 130a and 130b may be referred to as user device (or devices) 130 herein.

The user device 130 may submit a search query to the network-based commerce system 105. The search machine 110 may modify the search query before submitting the modified search query to the item database 115. The results of the search in the item database 115 may be returned to the user device 130 for display.

The user device 130 may present information to a user. For example, the user device 130 may be running a web browser presenting a web page. The user may indicate a search query to the user device 130. A search query defines the parameters of a search. The user device 130 may submit the search query to the search machine 110 running a search application that searches items stored in the item database 115. For example, the user may enter a search string into a hypertext markup language (HTML) form and press a button to cause the submission of the search query to the search machine 110. The search query may be transmitted using hypertext transport protocol (HTTP) over transmission control protocol/Internet protocol (TCP/IP). The search machine 110 may send the results of the search query back to the user device 130. The user device 130 may present the search results received from the search machine 110 to the user.

Also shown in FIG. 1 are users 132a and 132b. One or both of the users 132a and 132b may be a human user, a machine user (e.g., a computer configured by a software program to interact with the user device 130), or any suitable combination thereof (e.g., a human assisted by a machine or a machine supervised by a human). The user 132a is not part of the network environment 100, but is associated with the user device 130a and may be a user of the user device 130a. For example, the user device 130a may be a desktop computer, a vehicle computer, a tablet computer, a navigational device, a portable media device, a smart phone, a smart watch, or a pair of smart glasses belonging to the user 132a. Likewise, the user 132b is not part of the network environment 100, but is associated with the user device 130b. As an example, the user device 130b may be a desktop computer, a vehicle computer, a tablet computer, a navigational device, a portable media device, a smart phone, a smart watch, or a pair of smart glasses belonging to the user 132b.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the search machine 110 and the user device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

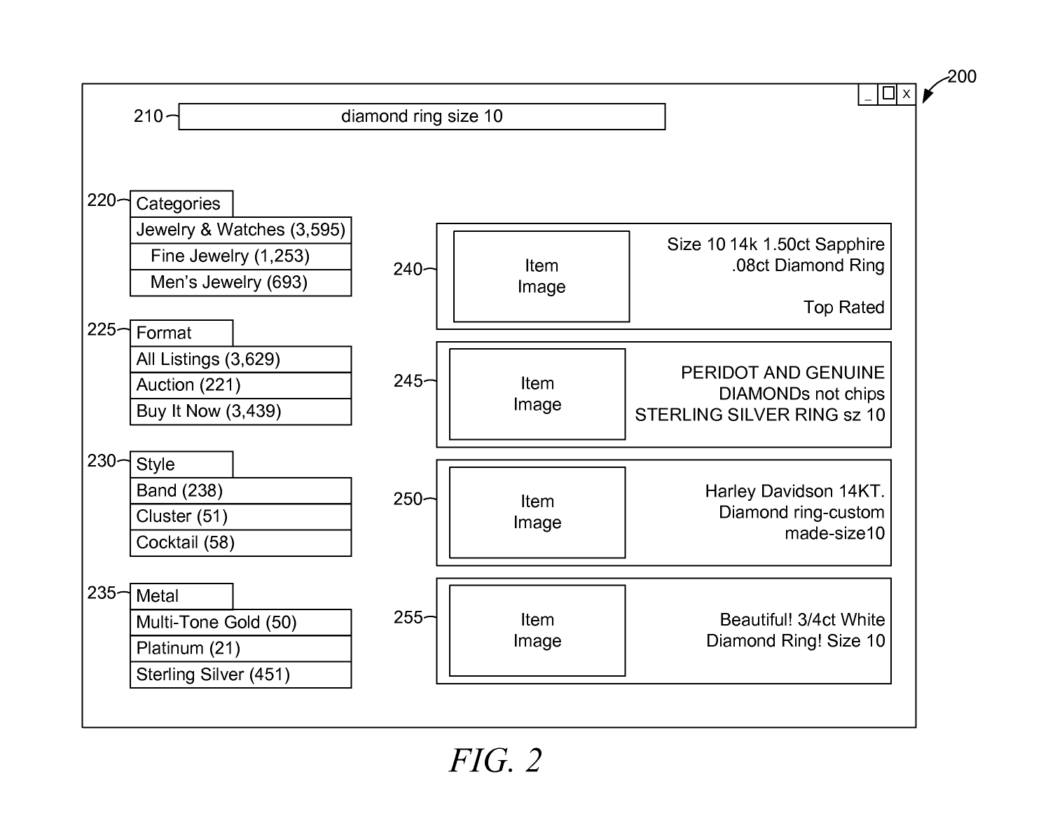

FIG. 2 is a screen diagram 200 illustrating a type of search phrase modification, according to some example embodiments. As shown in the screen diagram 200, the user has entered a search string of “diamond ring size 10” in a search string entry field 210.

Filters 220-235 are operable to limit the result set shown to the user. The filters 220-235 may operate as buttons, wherein selecting a filter directly causes the presentation of filtered results to the user. Alternatively, the filters 220-235 may be associated with radio buttons or checkboxes, such that the user may make a number of filter selections before submitting the set of selections. For example, the category of “Fine Jewelry,” shown as part of the filter 220, labeled “Categories,” may be operable as a button to cause the re-evaluation of the query limited to results within the category of “Fine Jewelry.” As another example, the metals of “Multi-Tone Gold” and “Platinum,” shown as part of the filter 235, labeled “Metal,” may be presented with corresponding check boxes. After the user checks the checkboxes corresponding to each metal, a submit button or the like may be used to submit the query and generate results limited to the selected metals.

The filters 220-235 may correspond to attributes of a query. For example, the items 240-255 may be assigned to one or more categories and sub-categories (corresponding to filter 220) and items for sale may be assigned to one or more sales formats (corresponding to filter 225). Similarly, rings may be assigned to one or more ring-specific styles (corresponding to filter 230) and metals (corresponding to filter 235).

The results 240-255 may each include an image of an item, a title of the item, and attributes of the item or the seller of the item. For example, the result 240 shows a title of “Size 10 14 k 1.50 ct Sapphire 0.08 ct Diamond Ring,” along with an attribute of the seller as being “Top Rated.”

The search string has been modified by the search machine 110 to treat the terms “size” and “10” as a phrase. Accordingly, only items that contain the phrase “size 10” or its equivalent in the title or description of the item listing are returned. For example, the results 240 and 255 contain the phrase “Size 10” in the title of the item. In some example embodiments, equivalents of the phrase are omitted, searching is performed only in the title of the item, or both. In this example embodiment, other portions of the system may further alter the search phrase. For example, the result 245 contains the phrase “sz 10,” but not “size 10,” in the title. That is, “sz” is treated as an equivalent for “size” in this query, even as the query was converted from “size AND 10” to the phrase “size 10.” Similarly, the result 250 contains “size10,” without a space between the word “size” and the number “10.” This is also treated as an equivalent for the phrase “size 10.”

In the example embodiment of FIG. 2, no indication is provided to the user that the terms “size” and “10” have been treated as a phrase. In other example embodiments, an indication of the phrase modification is provided. For example, the text entered into the search string entry field 210 can be replaced with the modified search string. As another example, the modified search string may be presented above the search results, as a tool tip, or in another way. For example, the color of the text in the search string entry field 210 may be changed (e.g., from black to green) to indicate that the search query was modified. By hovering over the search string entry field 210, the modified search query may be displayed in a tool tip.

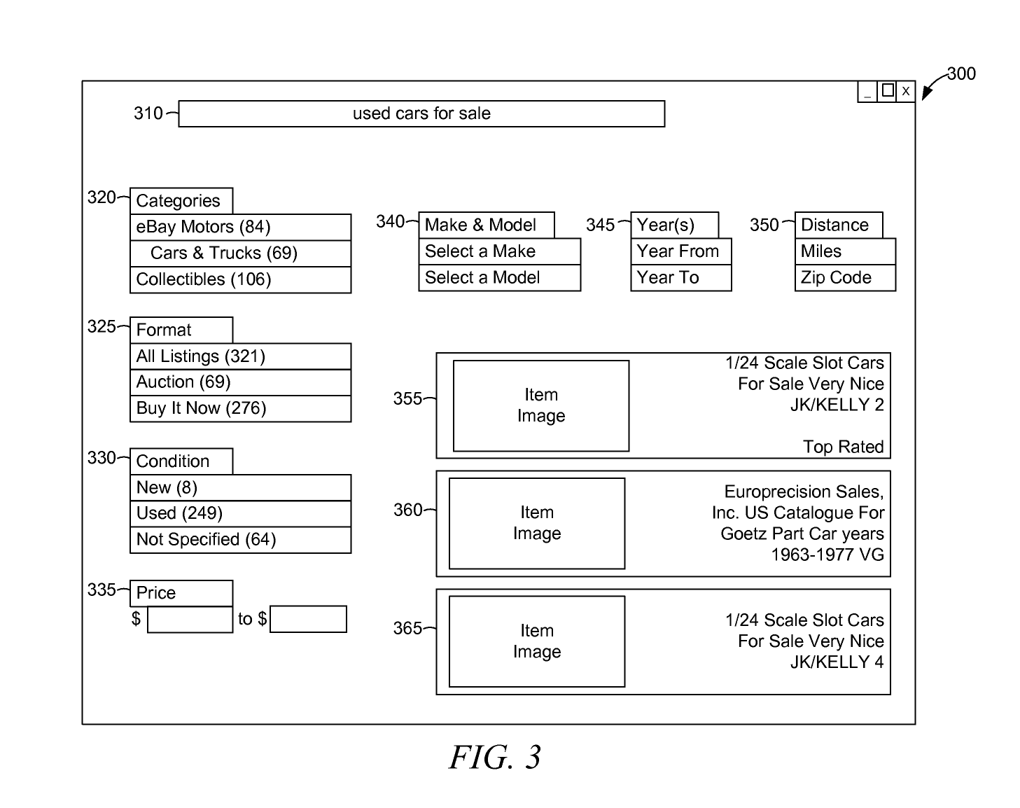

FIG. 3 is a screen diagram 300 illustrating a type of search phrase modification, according to some example embodiments. As shown in the screen diagram 300, the user has entered a search string of “used cars for sale” in a search string entry field 310. The search string has been modified by the search machine 110 to treat the term “used” as an attribute as well as a term. In some example embodiments, the term “used” is treated as an attribute and instead of as a term. In these example embodiments, some of the items returned to the user will not contain “used” in the title or description of the item listing.

In the example embodiment of FIG. 3, no indication is provided to the user that the term “used” has been treated as an attribute. In other example embodiments, an indication of the attribute modification is provided. For example, a checkbox for the “used” condition in the filter 330 may be checked. Similarly, in embodiments in which the term is replaced, the text entered into the search string entry field 210 can be replaced with the modified search string, lacking the term “used.”

Filters 320-350 are operable to limit the result set shown to the user. The filters 320-350 may operate as buttons, wherein selecting a filter directly causes the presentation of filtered results to the user. Alternatively, the filters 320-350 may be associated with radio buttons, text fields, or checkboxes, such that the user may make a number of filter selections before submitting the set of selections. For example, the category of “Cars & Trucks,” shown as part of the filter 320, labeled “Categories,” may be operable as a button to cause the re-evaluation of the query limited to results within the category of “Cars & Trucks.” As another example, the price filter 335 may be associated with two text fields. After the user enters a minimum price, a maximum price, or both into the text fields, a submit button or the like may be used to submit the query and generate results limited to the entered price range.

The results 355-365 may each include an image of an item, a title of the item, and attributes of the item or the seller of the item. For example, the result 355 shows a title of “ 1/24 Scale Slot Cars For Sale Very Nice JK/KELLY 2,” along with an attribute of the seller as being “Top Rated.”

The search string has been modified by the search machine 110 to treat the term “used” as an attribute. Accordingly, only items that have the condition of “used” are returned. In this case, the condition of the items is an attribute. The condition filter 330 may be operable by the user to override the automatic determination that used was intended to be treated as an attribute. As shown in FIG. 3, 249 used items matching the modified search query are available, along with 8 new items. Accordingly, the user is presently viewing the first results of the 249 used items, but is enabled to select “new” as the condition, and receive the 8 results for new items (or a subset thereof).

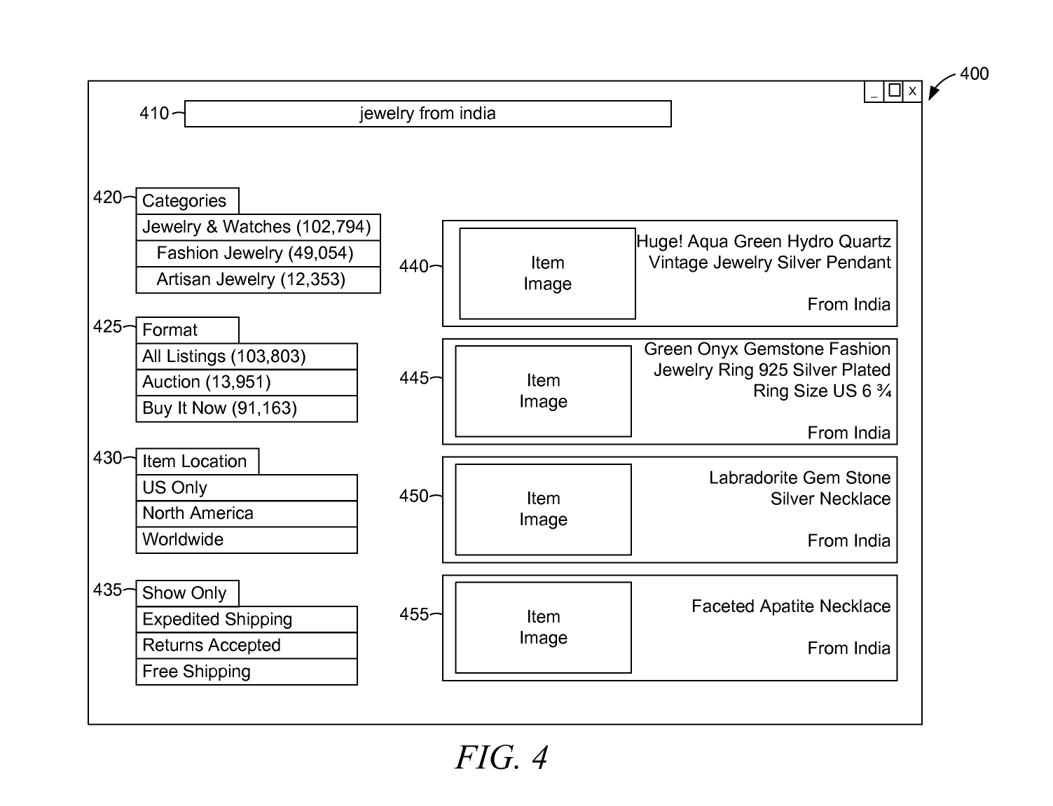

FIG. 4 is a screen diagram 400 illustrating a type of search phrase modification, according to some example embodiments. As shown in the screen diagram 400, the user has entered a search string of “jewelry from india” in a search string entry field 410. The search string has been modified by the search machine to treat the terms “from India” as a search within the country-origin attribute. Accordingly, some of the items returned to the user do not contain “from” or “India” in the title or description of the item listing, and only items originating from India have been returned.

In the example embodiment of FIG. 4, no indication is provided to the user that the terms “from India” have been treated as an attribute. In other example embodiments, an indication of the attribute modification is provided. For example, the text entered into the search string entry field 210 can be replaced with the modified search string, lacking the terms “from” and “India.” Similarly, a checkbox for an “India” attribute (not shown) in the item location filter 430 may be checked.

Filters 420-435 are operable to limit the result set shown to the user. The filters 420-435 may operate as buttons, wherein selecting a filter directly causes the presentation of filtered results to the user. Alternatively, the filters 420-435 may be associated with radio buttons, text fields, or checkboxes, such that the user may make a number of filter selections before submitting the set of selections. For example, the category of “Fashion Jewelry,” shown as part of the filter 420, labeled “Categories,” may be operable as a button to cause the re-evaluation of the query limited to results within the category of “Fashion Jewelry.” As another example, each attribute of the attribute filter 435 may be associated with a corresponding check box. After the user selects one or more of the check boxes, a submit button or the like may be used to submit the query and generate results limited to the selected attributes.

The results 440-455 may each include an image of an item, a title of the item, and attributes of the item or the seller of the item. For example, the result 450 shows a title of “Labradorite Gem Stone Silver Necklace,” along with an attribute of the item as being “From India.”

The search string has been modified by the search machine 110 to treat the phrase “from india” as an attribute. Accordingly, only items that have the condition of being “from India” are returned.

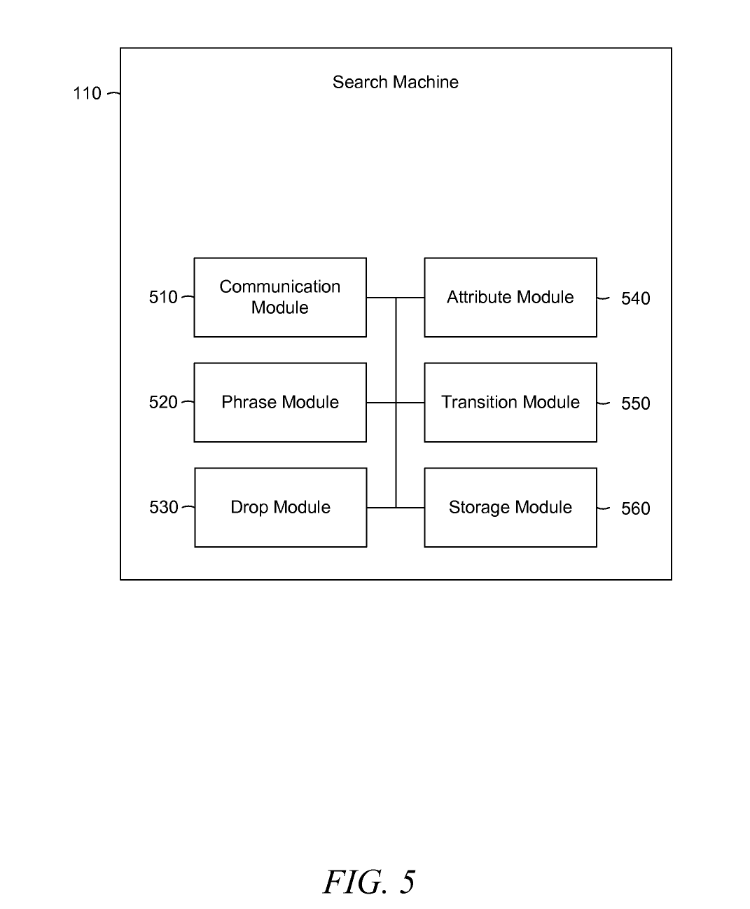

FIG. 5 is a block diagram illustrating components of the search machine 110, according to some example embodiments. The search machine 110 is shown as including a communication module 510, a phrase module 520, a drop module 530, an attribute module 540, a transition module 550, and a storage module 560, all configured to communicate with each other (e.g., via a bus, shared memory, a switch, or application programming interfaces (APIs)). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 510 may control communication with the user device 130 and the item database 115. The communication module 510 may also send data to the storage module 560, for storage on the search machine 110 or the item database 115.

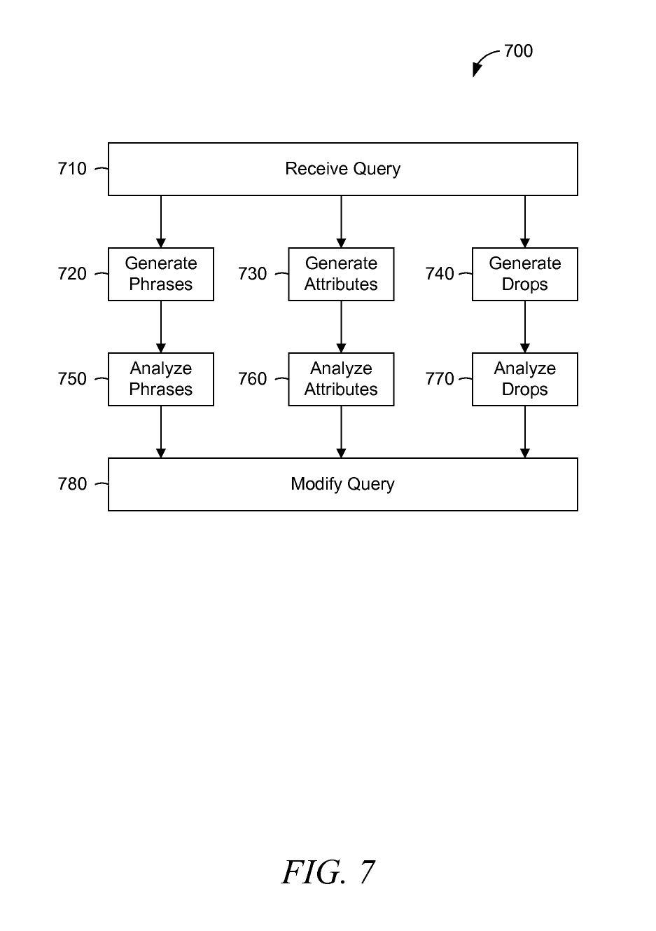

After the communication module 510 receives a search string from the user device 130, the phrase module 520 may modify the search string by replacing one or more search terms with a search phrase. For example, the search terms “size” and “10” may be replaced by the phrase “size 10.” The modification of the search string may be based on a determination that better results will be given using the modified string, as discussed in more detail with respect to FIGS. 7-10, below.

The drop module 530 may modify the search string by dropping one or more search terms from a search phrase. For example, if the search is being performed on an e-commerce site in which all items are for sale, the search terms “for” and “sale” may be dropped. Similarly, if the search is being performed with a web search tool, the search terms “web” and “page” may be dropped. Additional example words to drop include “and”, “cheap”, “only”, “of”, “is”, “for”, “will”, “with”, and “into”. The modification of the search string may be based on a determination that better results will be given using the modified string, as discussed in more detail with respect to FIGS. 7-10, below.

The drop words may be determined by mining a database of prior user interactions. Whenever a user enters one search string, sees results, and enters another search string, there is a transition between the two search strings. The first query is the pre-transition query and the second query is the post-transition query. Once a particular transition has been seen at least a threshold number of times (e.g., 1 time, 10 times, 100 times), the second search string may be considered as a possible refinement of the first search string. When the second search string is the same as the first search string except that one or more terms have been dropped, those terms may be drop candidates. In some example embodiments, the set of drop candidates is further refined by limiting the possible refinements to those transitions for which the post-transition query has a higher engagement rate than the pre-transition query.

The attribute module 540 may modify the search string by converting one or more search terms in a search string to attribute searches. For example, terms such as “from India” or “in California” may be converted to search for the named location in the location attribute of the item. Similarly, a term such as “since 1993” or “before April” may be converted to search for the named date or date range in the publication date attribute of the item. Likewise, a term such as “auction” may be converted to search for items being sold in an auction format. Other attributes may include shipping region, buy-it-now sales format, gift, payment options, classified advertising format, best offer sales format, adult content, promotional content, free shipping, daily deal, local to user, shipping method, item condition (e.g., new/used, mint/fine/good), color, language, brand, lot size, and the like. The modification of the search string may be based on a determination that better results will be given using the modified string, as discussed in more detail with respect to FIGS. 7-10, below.

The transition module 550 may determine the modifications to be made by the phrase module 520, the drop module 530, and the attribute module 540 by mining a database of prior user interactions. For example, when the user's search string is related by a transition to a second search string in which two or more terms of the search string are replaced by a phrase made up of the terms, those terms may be candidates for conversion to a phrase by the phrase module 520. As another example, when the user's search string is related by a transition to a second search string in which one or more terms of the search string are missing, those terms may be candidates for dropping by the drop module 530. Similarly, when the user's search string is related by a known transition to a second search string lacking terms corresponding to attributes, those terms may be candidates for conversion to attributes by the attribute module 540.

The storage module 560 may store the results of searches and subsequent user actions. In some example embodiments, replacement phrases, dropped terms, and attribute substitutions are stored in the storage module 560 for later retrieval by the phrase module 520, the drop module 530, the attribute module 540, or the transition module 550. In other example embodiments, replacement phrases, dropped terms, and attribute substitutions are generated dynamically by the phrase module 520, the drop module 530, and the attribute module 540 in response to the receipt of each search string.

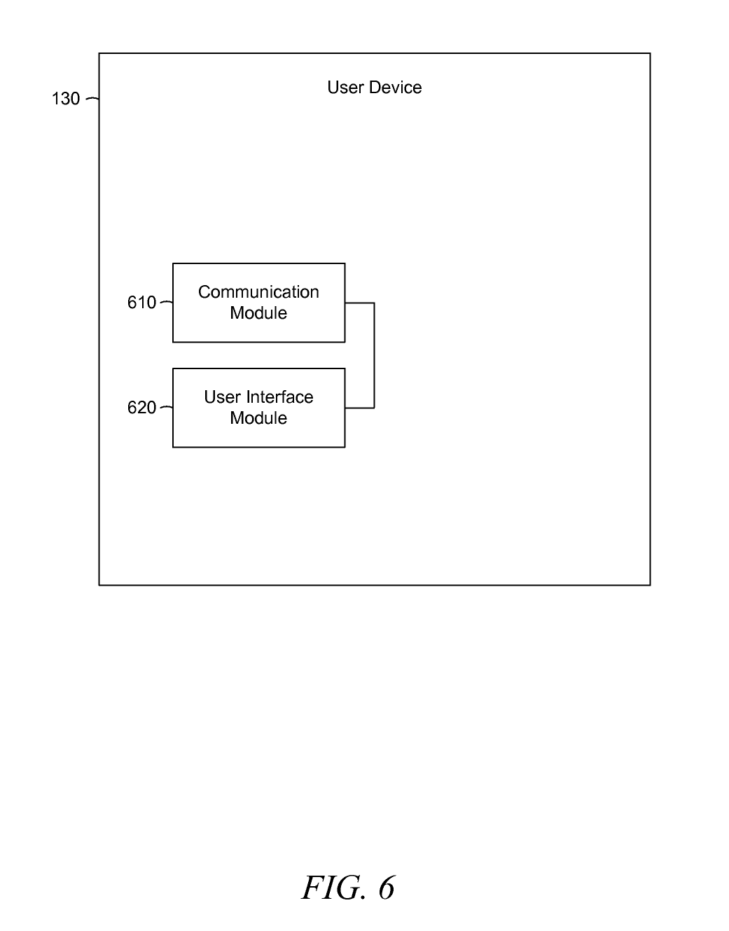

FIG. 6 is a block diagram illustrating components of the user device 130, according to some example embodiments. The user device 130 is shown as including a communication module 610 and a user interface module 620, configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 610 may communicate with the network-based commerce system 105, the search machine 110, the Internet, or any suitable combination thereof. Information received via the communication module 610 may be presented (e.g., displayed on a display device) via the user interface module 620. Search strings may be entered by a user using a user interface presented by the user interface module 620. The search strings may be communicated to the network-based commerce system 105 via the communication module 610. The items of interest generated by the network-based commerce system 105 may be presented to the user via the user interface module 620.

FIG. 7 is a flowchart illustrating operations of a machine (e.g., the search machine 110) in performing a method 700 of search phrase modification, according to some example embodiments. Operations in the method 700 may be performed by the search machine 110, using modules described above with respect to FIG. 5.

In the operation 710, a user query is received. For example, the user query may be the string “white apple tv.”

In the operation 720, a set of phrases is chosen or generated, each phrase being in the user query. For example, if the user query is “white apple tv”, the phrases may be “white apple”, “apple tv”, and “white apple tv”.

In the operation 730, a set of attributes or attribute combinations is chosen or generated. The set of attributes or attribute combinations may be selected based on the popularity of applying those attributes (e.g., the frequency with which they have been applied in the past by users), based on all possible attributes, either singly or in combination, based on terms in the query, or selected by an administrator. For example, the set of attributes or attribute combinations may include a specific brand, a specific price range, a specific color and size, a specific author and year of publication, and so on. As another example, if the user query is “new white apple tv,” the term “new” may be recognized as matching an attribute for new items, and the attribute “new” may be added to the set of attributes.

In the operation 740, a set of dropped terms is chosen or generated, each dropped term being in the user query. For example, if the user query is “white apple tv,” the dropped terms may be selected from “white,” “apple,” and “tv.”

In the operations 750-770, prior user engagements are analyzed. For example, prior user engagements may be selected from a database containing prior user searches and item interactions. Engagement with an item resulting from the user query may include an auction bid, a fixed-price purchase, a detail view of the item, and the like.

In the operation 750, for each phrase in the set of phrases, a phrase engagement ratio for the set of engagements (calculated using equation 1110) and a phrase exposure ratio for the set of engagements (calculated using equation 1120) may be calculated. In some example embodiments, other ways of determining the phrase engagement ratio and the phrase exposure ratio are used. The phrase engagement ratio and phrase exposure ratio may indicate the quality of the phrase. In one example embodiment, the phrase with the highest phrase engagement ratio above 95% of phrases with positive phrase exposure ratios is chosen. In this example embodiment, if no phrase meets the minimum criteria, no phrase is chosen. When no phrase is chosen, the query will not be modified to convert terms into a phrase.

In some example embodiments, in addition to or instead of applying a cut-off value for each criterion, a combined score is calculated. For example, the phrase engagement ratio may be added to the phrase exposure ratio to generate a score. Each of the ratios may be multiplied by a scale factor to appropriately weight the two components of the score. The length of the phrase may also considered as a factor. Continuing with the example above, the phrase “white apple tv” may be given additional weight relative to the two-word phrases. This may be treated as a multiplicative factor, e.g., the score for each phrase may be multiplied by the number of words in the phrase, or an additive factor, e.g., the length of the phrase may be added to the score. In some example embodiments, the length of the phrase also has a scale factor.

In some example embodiments, multiple phrases may be chosen. In these embodiments, phrases may or may not be allowed to overlap. For example, the search query “white apple tv” may result in the generation of phrases “white apple” and “apple tv.” When both of these phrases meet the criteria for substitution, one phrase may be substituted, as discussed above. Alternatively, both phrases may be substituted, resulting in the search query “‘white apple’ AND ‘apple tv.’” In this case, the phrases are allowed to overlap, since both phrases include the word “apple,” even though that word appeared only once in the original query. In embodiments where phrases are not allowed to overlap, multiple phrases may be allowed in general, but the highest-rated phrase selected when the phrases overlap. Thus, “‘white apple’ AND tv” would be the resulting search query when “white apple” had a higher score than “apple tv” and overlapping of terms was excluded.

In the operation 760, for each attribute (or attribute combination) in the set of attributes, an attribute engagement ratio for the set of engagements (calculated using equation 1130) and an attribute exposure ratio for the set of engagements (calculated using equation 1140) may be calculated. In some example embodiments, other ways of determining the attribute engagement ratio and the attribute exposure ratio are used. The attribute engagement ratio and attribute exposure ratio may indicate the quality of the attribute. In one example embodiment, the attribute with the highest attribute engagement ratio above 95% of attributes with positive attribute exposure ratios is chosen. In this example embodiment, if no attribute meets the minimum criteria, no attribute is chosen. When no attribute is chosen, the query will not be modified to add an attribute.

In the operation 770, for each drop (or drop combination) in the set of drops, a drop engagement ratio for the set of engagements (calculated using equation 1150) and a drop exposure ratio for the set of engagements (calculated using equation 1160) may be calculated. In some example embodiments, other ways of determining the drop engagement ratio and the drop exposure ratio are used. The drop engagement ratio and drop exposure ratio may indicate the quality of the drop. In one example embodiment, the drop with the highest attribute engagement ratio above 95% of drops with positive drop exposure ratios is chosen. In this example embodiment, if no drop meets the minimum criteria, no drop is chosen. When no drop is chosen, the query will not be modified to drop terms.

In the operation 780, one or more of the analyzed modifications is chosen and the query is modified. For example, if one of the phrases of the query is chosen, the query will be processed with the terms of the phrase treated as a phrase instead of as separate terms. For example, “white apple tv” may be treated as “white AND ‘apple tv’” rather than “white AND apple AND tv”. As another example, if an attribute of “new” is chosen, the query will be processed with the attribute, either in addition to all terms of the original query, or as a substitution for one or more terms of the original query. For example, “white apple tv” may be treated as a search of items matching the search string “white apple tv” and having the attribute of being “new.” In this example, the attribute has been added to the search string. As another example, “new white apple tv” may also be treated as a search of items matching the search string “white apple tv” and having the attribute of being “new.” In this example, the search term “new” has been replaced by the attribute.

Independent of the operation 780, query rewriting (e.g., replacing a word with its base, permitting abbreviations to be used for a full word, etc.) may also be applied to the resulting query. The query rewriting may occur before or after the generation and analysis performed in the operations 720-770.

In FIG. 7, the operations 720-740 (and corresponding operations 750-770) are shown as being performed in parallel. In some example embodiments, only one or two of the parallel paths shown is followed. For example, phrases may be generated and analyzed (in the operations 720 and 750), while attributes and drops are not considered. In other example embodiments, operations are performed sequentially rather than in parallel. For example, the generation of drops in the operation 740 may occur after the generation and analysis of phrases in the operations 720 and 750. Similarly, FIG. 7 shows the modification of the query (the operation 780) occurring after the generation and analysis of the phrases, attributes and drops. In some example embodiments, the modification of the query occurs as an intermediate step. For example, the query may be modified after the phrase analysis of the operation 750 is complete, and that modified query used as the input query for the generation of drops in the operation 740.

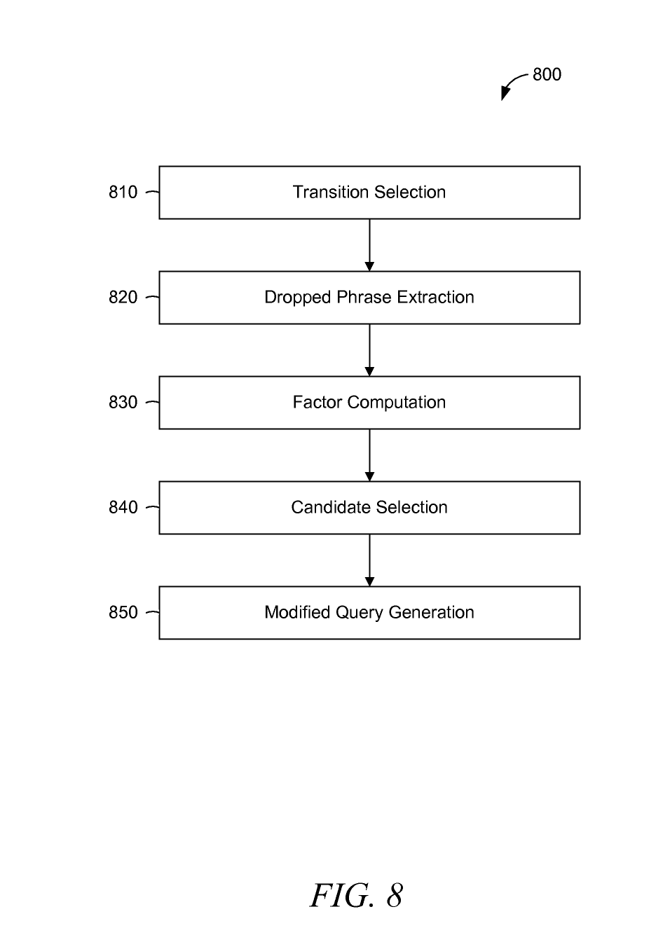

FIG. 8 is a flowchart illustrating operations of a machine (e.g., the search machine 110) in performing a method 800 of search phrase modification, according to some example embodiments. Operations in the method 800 may be performed by the search machine 110, using modules described above with respect to FIG. 5. As shown in FIG. 8, the method 800 includes operations 810, 820, 830, 840, and 850.

In the operation 810, an initial set of transitions is selected for analysis. The set of transitions may be selected based on the pre-transition query, the post-transition query, resulting engagement with items matching another query, or any suitable combination thereof. Engagement with an item may include an auction bid, a fixed-price purchase, a detail view of the item, and the like. In some example embodiments, the set of transitions is chosen based on the pre-transition query matching a user query.

In the operation 820, the set of transitions is limited to transitions in which the post-transition query is the same as the pre-transition query except that one or more of the words in the search string have been dropped. These transitions may show instances in which users have been dissatisfied with the search results and opted to search again without the dropped words.

In the operation 830, transitions in the set of transitions are analyzed. For example, if the percentage of post-transition queries that resulted in engagement is greater than the percentage of pre-transition queries that resulted in engagement, this may be a positive factor for the transition. As another example, a higher frequency of the transition may be a positive factor for the transition. A score may be generated for each transition and the post-transition query for the transition with the highest score chosen. If no transition has more than a minimum score, no transition may be chosen. When no transition is chosen, the original query will be processed.

In the operation 840, a transition is chosen. Based on the selected transition, the post-transition query will be processed instead of the original query (in the operation 850). Query rewriting (e.g., replacing a word with its base, permitting abbreviations to be used for a full word, etc.) may be applied to the resulting query.

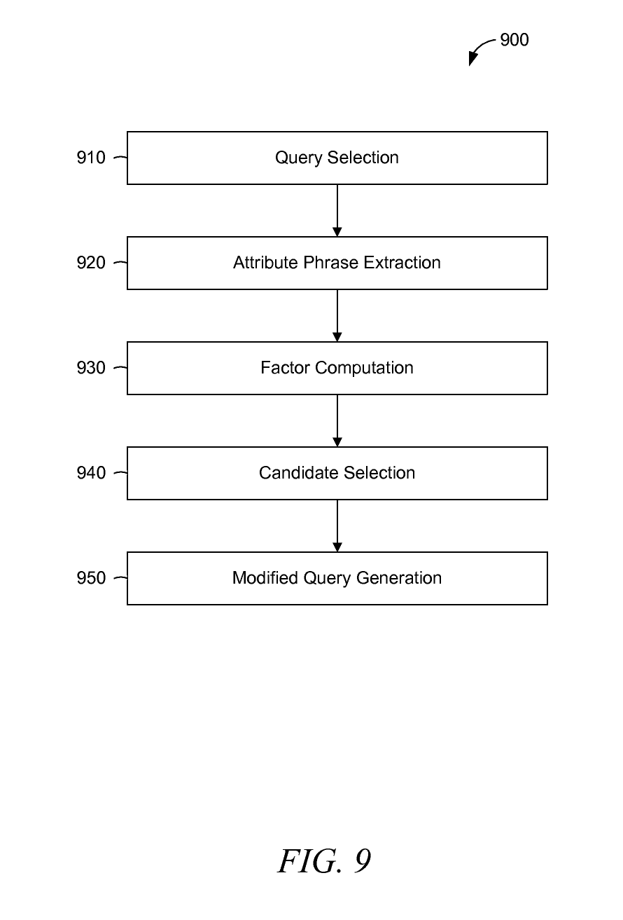

FIG. 9 is a flowchart illustrating operations of a machine (e.g., the search machine 110) in performing a method 900 of search phrase modification, according to some example embodiments. Operations in the method 900 may be performed by the search machine 110, using modules described above with respect to FIG. 5. As shown in FIG. 9, the method 900 includes operations 910, 920, 930, 940, and 950.

In the operation 910, an initial set of transitions is selected for analysis. The set of transitions may be selected based on the pre-transition query, the post-transition query, resulting engagement with items matching another query, or any suitable combination thereof. In some example embodiments, the set of transitions is chosen based on the pre-transition query matching a user query.

In the operation 920, the set of transitions is limited to transitions in which the post-transition query is the same as the pre-transition query except that one or more of the words in the search string have been replaced by an attribute. These transitions may show instances in which users have been dissatisfied with the search results and opted to search again by changing a search term to an attribute. For example, a user may search for “new tv,” be dissatisfied with the results, and search again for “tv” while limiting the results to items having the attribute of “new.” As another example, the pre-transition query may be “car auction” and the post-transition query may be “car” with the attribute “auction” selected.

In the operation 930, the transitions in the set are analyzed. For example, if the percentage of post-transition queries that resulted in engagement is greater than the percentage of pre-transition queries that resulted in engagement, this may be a positive factor for the transition. As another example, a higher frequency of the transition may be a positive factor for the transition. A score may be generated for each transition and the post-transition query for the transition with the highest score chosen. If no transition has more than a minimum score, no transition may be chosen. When no transition is chosen, the original query will be processed.

In the operation 940, a transition is chosen. Based on the selected transition, the post-transition query will be processed instead of the original query (in the operation 950). Query rewriting (e.g., replacing a word with its base, permitting abbreviations to be used for a full word, etc.) may be applied to the resulting query.

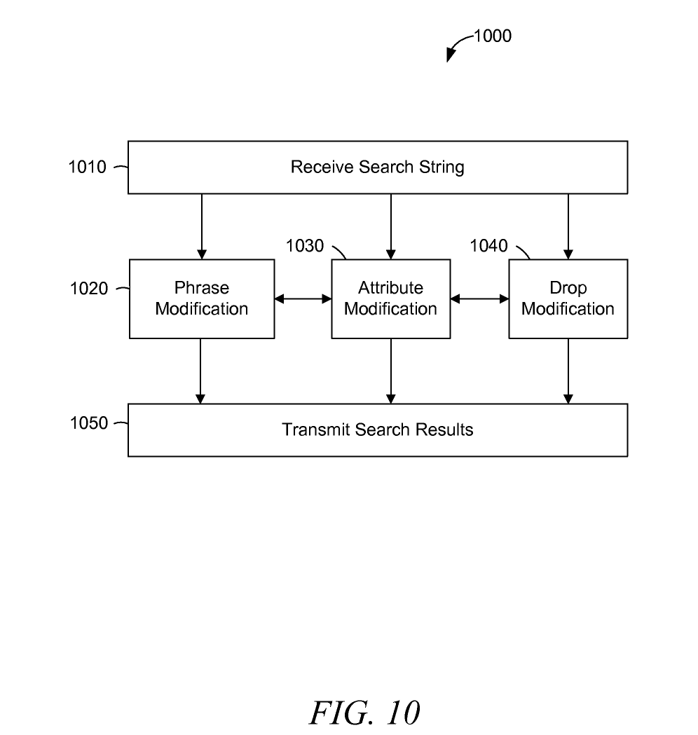

FIG. 10 is a flowchart illustrating operations of a machine (e.g., the search machine 110) in performing a method 1000 of search phrase modification, according to some example embodiments. Operations in the method 1000 may be performed by the search machine 110, using modules described above with respect to FIG. 5. As shown in FIG. 10, the method 1000 includes operations 1010, 1020, 1030, 1040, and 1050.

In the operation 1010, a server receives a search query. For example, the search machine 110 may receive a search query generated by a user of a user device 130. For example, a search query for a “new ipod nano with headphones” may be received.

In the operation 1020, the server modifies the query to treat some terms as a phrase. For example, the terms “ipod” and “nano” may be treated as the phrase “ipod nano.”

In the operation 1030, the server modifies the query to treat one or more terms as attribute search terms. For example, the term “new” may be treated as an attribute search instead of a keyword search.

In the operation 1040, the server modifies the query to drop one or more search terms. For example, the term “with” may be dropped.

The various modifications performed in the operations 1020-1040 may occur sequentially or in parallel. For example, the original search query may be modified in each way, and then one modified result chosen. Alternatively, the search results generated from all three modified queries may be combined. The selection of the modified query to use may be based on prior engagement with the resulting queries by previous users. For example, the query “new AND ‘ipod nano’ AND with AND headphones” may be a candidate query based on the results of the operation 1020. The query “ipod AND nano AND with AND headphones” with the attribute of “new” may be a candidate query based on the results of the operation 1030. The query “new AND ipod AND nano AND headphones” may be a candidate query based on the results of the operation 1030. The query “‘ipod nano’ AND headphones” with the attribute “new” may be a candidate query based on the results of the operations 1020-1040 combined. Other combined results may also be generated. For example, the results of the operations 1020 and 1030 may be combined while the results of the operation 1040 is ignored. In some example embodiments, only a single one of the three operations 1020, 1030, and 1040 is performed.

In the operation 1050, search results are generated for the chosen query and transmitted to the user. In some example embodiments, the chosen query is also transmitted to the user device for presentation to the user. For example, the user may be informed that the original query of “new ipod nano with headphones” was replaced by a query for “‘ipod nano’ AND headphones,” with the results limited to items having the attribute “new.”

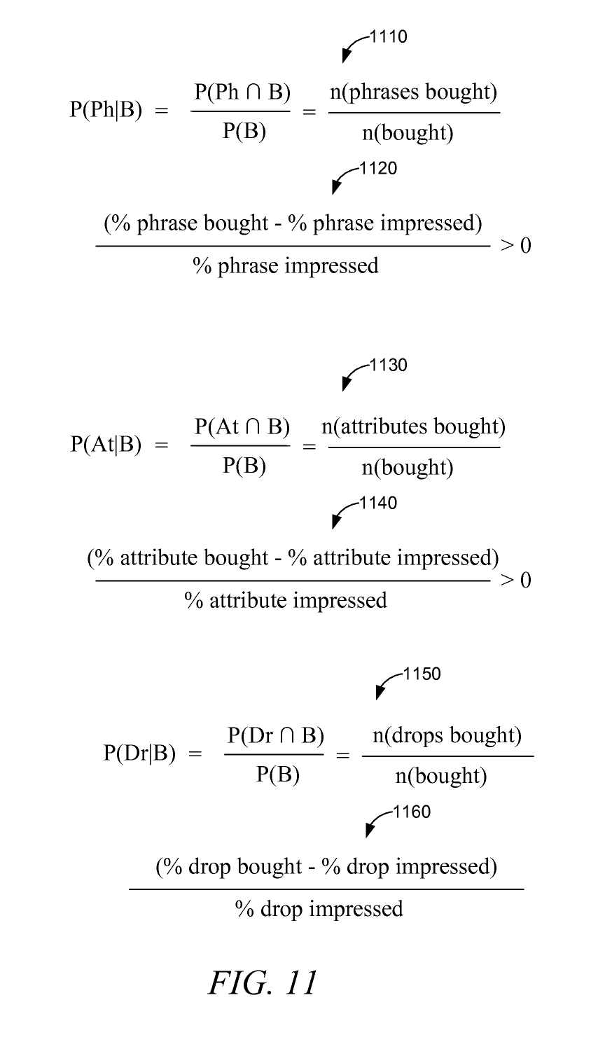

FIG. 11 shows equations used in operations of a search machine in performing methods of search phrase modification, according to some example embodiments.

Equation 1110 shows that the conditional probability of a phrase given than an item is bought is equal to the number of items bought containing the phrase divided by the total number of items bought. The conditional probability of a phrase may indicate the quality of the phrase. For example, a certain search string may return a set of results when executed as a non-phrase. 80% of the results may contain the search string as a phrase, while 99% of the items actually purchased as a result of the search may contain the search string as a phrase. In this case, the conditional probability of the phrase would be 99%. A threshold may be used to determine a good phrase (e.g., 95%).

For some data sets, the equation 1110 provides a high false positive rate when the frequency of engaged items is low. In these cases, it may be difficult to distinguish signal from noise with a string threshold. Beta-Binomial smoothing may be incorporated to reduce the false positive rate. By incorporating Beta-Binomial smoothing, the number of phrases engaged with is modeled as a binomial process and the Beta distribution is used to smooth the engaged efficiency.

Equation 1120 shows that the lift in bought items resulting from treating a search string as a phrase is the percentage of items bought that contain the search string as a phrase minus the percentage of items returned from a search treating the search string as a non-phrase that contains the phrase, divided by that latter percentage. A negative lift shows that the user is more likely to buy an item that does not contain the phrase than one that does. Accordingly, a negative lift may indicate that a set of terms in a search string should not be treated as a phrase, even if the conditional probability of equation 1110 indicates that the phrase is good. The use of lift may compensate for presentation bias. For example, if many results for a query contain certain terms in the query as a phrase, then equation 1110 will show a high conditional probability for the phrase, even if treating the terms as a phrase does not actually increase engagement. In such a case, the lift calculated using equation 1120 will show whether or not treating the terms as a phrase resulted in a higher engagement. Accordingly, the decision to substitute the phrase-replaced query for the original query may be based on the conditional probability exceeding a threshold and the lift being greater than zero.

Equations 1110 and 1120 may be used to determine the impact of changes other than phrase substitution. For example, to apply equation 1110 to attribute detection, the conditional probability of the attribute given than an item is bought is equal to the number of items bought having the attribute divided by the total number of items bought. The results of such substitutions are shown in equations 1130-1160.

According to various example embodiments, one or more of the methodologies described herein may facilitate providing information to a user regarding items of interest. Moreover, one or more of the methodologies described herein may facilitate the generation of sales by an electronic marketplace. Additionally, one or more of the methodologies described herein may facilitate the user's interaction with a search engine.

When these effects are considered in aggregate, one or more of the methodologies described herein may obviate a need for certain efforts or resources that otherwise would be involved in search phrase modification. Efforts expended by a user in identifying items of interest may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 12 is a block diagram illustrating components of a machine 1200, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 12 shows a diagrammatic representation of the machine 1200 in the example form of a computer system within which instructions 1224 (e.g., software, a program, an application, an applet, an app, or other executable code) for causing the machine 1200 to perform any one or more of the methodologies discussed herein may be executed, in whole or in part. In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a set-top box (STB), a personal digital assistant (PDA), a cellular telephone, a smartphone, a wearable computer, a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include a collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The machine 1200 may further include a graphics display 1210 (e.g., a plasma display panel (PDP), a light emitting diode (LED) display, a liquid crystal display (LCD), a projector, or a cathode ray tube (CRT)). The machine 1200 may also include an alphanumeric input device 1212 (e.g., a keyboard), a cursor control device 1214 (e.g., a mouse, a touchpad, a trackball, a joystick, a motion sensor, or other pointing instrument), a storage unit 1216, a signal generation device 1218 (e.g., a speaker), and a network interface device 1220.

The storage unit 1216 includes a machine-readable medium 1222 on which are stored the instructions 1224 embodying any one or more of the methodologies or functions described herein. The instructions 1224 may also reside, completely or at least partially, within the main memory 1204, within the processor 1202 (e.g., within the processor's cache memory), or both, during execution thereof by the machine 1200. Accordingly, the main memory 1204 and the processor 1202 may be considered machine-readable media. The instructions 1224 may be transmitted or received over a network 1226 (e.g., the network 190) via the network interface device 1220.

As used herein, the term “memory” refers to a machine-readable medium able to store data temporarily or permanently, and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., the machine 1200), such that the instructions, when executed by one or more processors of the machine (e.g., the processor 1202), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
a communication module configured to receive a search query;
an attribute module configured to:
identify a plurality of prior uses of the search query;
determine a percentage of engaged items resulting from the plurality of prior uses that have an attribute;
determine that the attribute percentage exceeds an attribute threshold; and
modify the search query to include the attribute based on the determination that the attribute percentage exceeds the attribute threshold; and wherein
the communication module is further configured to transmit search results based on the modified search query.

2. The system of claim 1, further comprising:
a transition module configured to:
identify a set of prior uses of the search query, each prior use of the search query of the set of prior uses having a corresponding subsequent search query;
determine a count of transitions for each subsequent search query; and
generate a set of candidate queries including subsequent search queries for which the count of transitions exceeds a threshold; and wherein
the attribute module is further configured to:
determine that the modified search query is in the set of candidate queries.

3. The system of claim 1, wherein the attribute module is further configured to:
determine a lift of the modified search query relative to the received search query; and
determine that the lift exceeds a lift threshold; and wherein
the modifying of the search query is based on the determination that the lift exceeds the lift threshold.

4. The system of claim 1, further comprising a phrase module configured to:
combine a set of terms in the search query to generate a phrase;
determine a percentage of the engaged items matching the phrase;
determine that the phrase percentage exceeds a threshold; and
modify the search query by replacing the combined set of terms with the phrase based on the determination that the phrase percentage exceeds the threshold.

5. The system of claim 4, wherein the phrase module, the attribute module, and the communication module are different modules.

6. The system of claim 4, further comprising:
a transition module configured to:
identify a set of prior uses of the search query, each prior use of the search query of the set of prior uses having a corresponding subsequent search query;
determine a count of transitions for each subsequent search query; and
generate a set of candidate queries including subsequent search queries for which the count of transitions exceeds a threshold; and wherein
the phrase module is further configured to:
determine that the modified search query is in the set of candidate queries.

7. The system of claim 4, wherein the phrase module is further configured to:
combine an additional set of terms in the search query to generate an additional phrase;
determine a percentage of the engaged items matching the additional phrase; and
determine that the additional phrase percentage exceeds the threshold; and wherein
the modifying of the search query to replace the combined set of terms is based on the phrase percentage being larger than the additional phrase percentage.

8. The system of claim 7, wherein the set of terms and the additional set of terms have at least one member in common.

9. The system of claim 1, further comprising a drop module configured to:
determine a percentage of the engaged items not matching a term of the search query;
determine that the non-matching percentage exceeds a drop threshold; and
modify the search query to exclude the term based on the determination that the non-matching percentage exceeds the drop threshold.

10. The system of claim 9, further comprising:
a transition module configured to:
identify a set of prior uses of the search query, each prior use of the search query of the set of prior uses having a corresponding subsequent search query;
determine a count of transitions for each subsequent search query; and
generate a set of candidate queries including subsequent search queries for which the count of transitions exceeds a threshold; and wherein
the drop module is further configured to:
determine that the modified search query is in the set of candidate queries.

11. A method comprising:
receiving a search query;
identifying a plurality of prior uses of the search query;
determining a percentage of engaged items resulting from the plurality of prior uses that have an attribute;
determining that the attribute percentage exceeds an attribute threshold;
modifying the search query to include the attribute based on the determination that the attribute percentage exceeds the attribute threshold; and
transmitting search results based on the modified search query.

12. The method of claim 11, further comprising:
identifying a set of prior uses of the search query, each prior use of the search query of the set of prior uses having a corresponding subsequent search query;
determining a count of transitions for each subsequent search query;
generating a set of candidate queries including subsequent search queries for which the count of transitions exceeds a threshold; and
determining that the modified search query is in the set of candidate queries.

13. The method of claim 11, further comprising:
determining a lift of the modified search query relative to the received search query; and
determining that the lift exceeds a lift threshold; and wherein
the modifying of the search query is based on the determination that the lift exceeds the lift threshold.

14. The method of claim 11, further comprising:
combining a set of terms in the search query to generate a phrase;
determining a percentage of the engaged items matching the phrase;
determining that the phrase percentage exceeds a threshold; and
modifying the search query to replace the combined set of terms with the phrase based on the determination that the phrase percentage exceeds the threshold.

15. The method of claim 14, further comprising:
identifying a set of prior uses of the search query, each prior use of the search query of the set of prior uses having a corresponding subsequent search query;
determining a count of transitions for each subsequent search query;
generating a set of candidate queries including subsequent search queries for which the count of transitions exceeds a threshold; and
determining that the modified search query is in the set of candidate queries.

16. The method of claim 14, further comprising:
combining an additional set of terms in the search query to generate an additional phrase;
determining a percentage of the engaged items matching the additional phrase; and
determining that the additional phrase percentage exceeds the threshold; and wherein
the modifying of the search query to replace the combined set of terms is based on the phrase percentage being larger than the additional phrase percentage.

17. The method of claim 16, wherein the set of terms and the additional set of terms have at least one member in common.

18. The method of claim 11, further comprising:
determining a percentage of the engaged items not matching a term of the search query;
determining that the non-matching percentage exceeds a drop threshold; and
modifying the search query to exclude the term based on the determination that the non-matching percentage exceeds the drop threshold.

19. The method of claim 18, further comprising:
identifying a set of prior uses of the search query, each prior use of the search query of the set of prior uses having a corresponding subsequent search query;
determining a count of transitions for each subsequent search query;
generating a set of candidate queries including subsequent search queries for which the count of transitions exceeds a threshold; and
determining that the modified search query is in the set of candidate queries.

20. A non-transitory machine-readable storage medium comprising instructions that, when executed by one or more processors of a machine, cause the machine to perform operations comprising:
receiving a search query;
identifying a plurality of prior uses of the search query;
determining a percentage of engaged items resulting from the plurality of prior uses that have an attribute;
determining that the attribute percentage exceeds an attribute threshold;
modifying the search query to include the attribute based on the determination that the attribute percentage exceeds the attribute threshold; and
transmitting search results based on the modified search query.
